(19) United States
(12) Patent Application Publication
(10) Pub. No.: US 2011/0099103 A1
(43) Pub. Date: Apr. 28, 2011

(54) Automated Escheatment Process

(75) Inventors: Kathleen P. Minnis, Jacksonville, FL (US); Laura M. Howard, Matthews, NC (US)

(73) Assignee: Bank of America Corporation, Charlotte, NC (US)

(21) Appl. No.: 12/686,450

(22) Filed: Jan. 13, 2010

Related U.S. Application Data
(60) Provisional application No. 61/253,959, filed on Oct. 22, 2009.

(51) Int. Cl. G06Q 40/00; G06Q 90/00

(52) U.S. Cl. 705/39; 705/500

(57) ABSTRACT

A system and method of identifying an appropriate state to which unclaimed funds should escheat is presented. The system and method may include receiving data regarding unclaimed funds and identifying an owner of the funds, as well as the last known state of residence of the owner. The unclaimed funds are assigned a state identifier identifying the state to which the funds may escheat. At a predetermined time, or on demand, the funds may escheat to the designated state.

### CROSS REFERENCE TO RELATED APPLICATIONS

This application is a non-provisional application of and claims the benefit of priority from U.S. Application Ser. No. 61/253,959, entitled “Automated Escheatment Process,” filed Oct. 22, 2009, which is incorporated herein by reference in its entirety.

### BACKGROUND

Processing of financial transactions is prone to error due to the substantial volume of transactions conducted on a daily basis and the speed with which the transactions must be processed due to customer expectations and demand. Consequently, adjustments are often necessary to correct any errors such as errors in deposit and withdrawal amounts. Further, oftentimes financial institutions are in possession of funds that belong to an individual or customer but have not been claimed by the customer. These unclaimed funds may be the result of an adjustment to a transaction that included an error, a check that was never cashed, etc. These unclaimed funds are required, by law, to escheat to the state of residence of the rightful owner of the funds. However, it is often difficult to ascertain the proper state to escheat funds to because a location of a customer may not be known, the customer may not be identified, and the like. Accordingly, a system and method of identifying the appropriate state to escheat funds to would be advantageous.

### SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the description below.

According to one or more aspects, data associated with unclaimed funds may be received from various sources. In some examples, the data may include information such as an amount, name of owner, account number associated with funds, etc. The data may, in some arrangements, be received at an owner identification system which may match the information associated with the unclaimed funds to last known information regarding the owner. If a match is made, the unclaimed funds and associated owner information may be transmitted to a state identifier assignment system which may assign a state identifier to the unclaimed funds. The funds may then escheat to the state associated with the state identifier.

### BRIEF DESCRIPTION OF THE DRAWINGS

The present disclosure is illustrated by way of example and not limited in the accompanying figures in which like reference numerals indicate similar elements.

FIG. 1 illustrates an example of a suitable operating environment in which various aspects of the disclosure may be implemented.

FIG. 2 illustrates an example network environment for processing unclaimed funds data according to one or more aspects described herein.

FIG. 3 illustrates an example data flow for processing unclaimed funds data and identifying a state for the funds to escheat to according to one or more aspects described herein.

FIG. 4 illustrates one example method by which a financial institution may receive unclaimed funds data and automatically determine a state to which the funds should escheat according to one or more aspects described herein.

FIG. 5 illustrates one example method of forwarding identified transactions or funds to an identified state according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the present claimed subject matter.

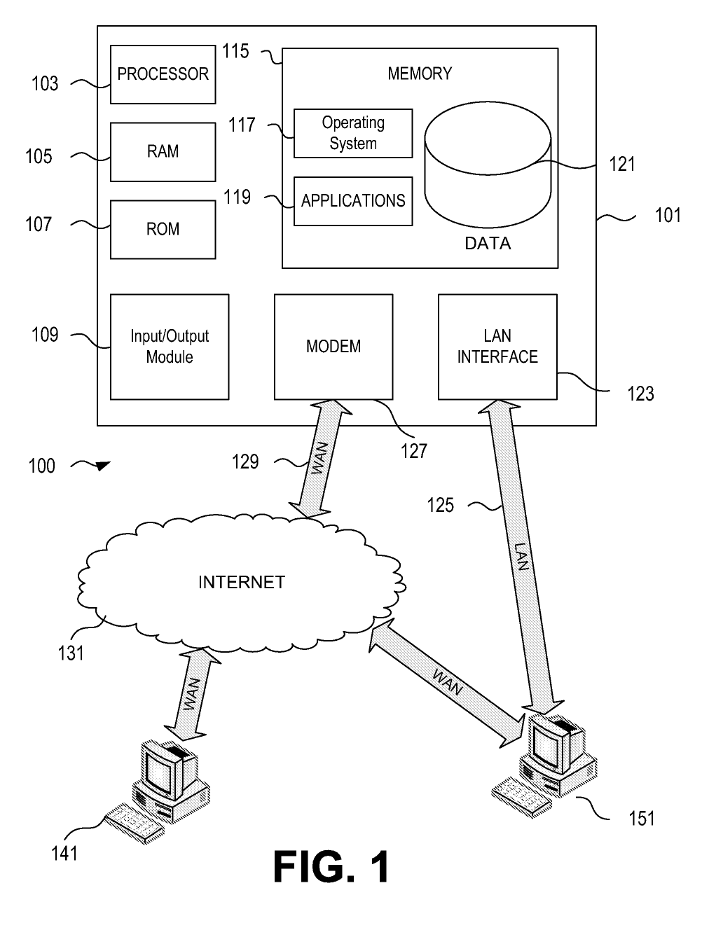

FIG. 1 illustrates a block diagram of a generic computing device 101 (e.g., a computer server) in computing environment 100 that may be used according to an illustrative embodiment of the disclosure. The computer server 101 may have a processor 103 for controlling overall operation of the server and its associated components, including random access memory (RAM) 105, read-only memory (ROM) 107, input/output (I/O) module 109, and memory 115.

I/O 109 may include a microphone, mouse, keypad, touch screen, scanner, optical reader, and/or stylus (or other input device(s)) through which a user of server 101 may provide input, and may also include one or more of a speaker for providing audio output and a video display device for providing textual, audiovisual and/or graphical output. Software may be stored within memory 115 and/or other storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown).

The server 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 may be connected to the LAN 125 through a network interface or adapter 123. When used in a WAN networking environment, the server 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Computing device 101 and/or terminals 141 or 151 may also be mobile terminals (e.g., mobile phones, PDAs, notebooks, etc.) including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by one or more computers and/or one or more processors associated with the computers. Generally, program modules include routines, programs, objects, components, data structures, etc. that perform particular tasks or implement particular abstract data types. Aspects of the disclosure may also be practiced in distributed computing environments where tasks are performed by remote processing devices that are linked through a communications network. In a distributed computing environment, program modules may be located in both local and remote computer storage media including memory storage devices.

The system, devices and networks of FIG. 1 may, in one or more arrangements, be used to provide transaction adjustment functionality. Transaction adjustments are used to resolve discrepancies between what is claimed as owed or paid and what is actually owed or paid. For example, a check adjustment may be needed where Bank A receives $100 from Bank B for a $1000 check deposited at Bank A. The error may result from a misread of the check or check image, amount entry error, check reference number entry error or the like. Accordingly, an adjustment must be applied to the check transaction to compensate Bank A for the difference, i.e., $900. A system may be used to streamline the research and resolution of transaction adjustment cases. The system may provide automated workflow procedures for the entry and building of transaction adjustment cases, organization of transaction adjustment cases, creation of user interfaces for data entry, editing and viewing of case information including check images, interfacing with legacy and third party applications and the like. For example, the system may receive data from a transaction data collection system and automatically populate fields to build a transaction case.

In some arrangements, funds associated with various adjustments, or funds from an uncashed check, etc. may be identified as unclaimed funds. Generally, as may be legally required in some jurisdictions, after a predetermined time for which the financial institution may hold the funds, any unclaimed funds must escheat to the last known state of residence of the owner of the funds. The predetermined period of time may be determined by state laws and, in some examples, may be between three and five years. In order to transfer the funds to a state, an owner of the funds must be a identified and the state associated with the owner must also be identified.

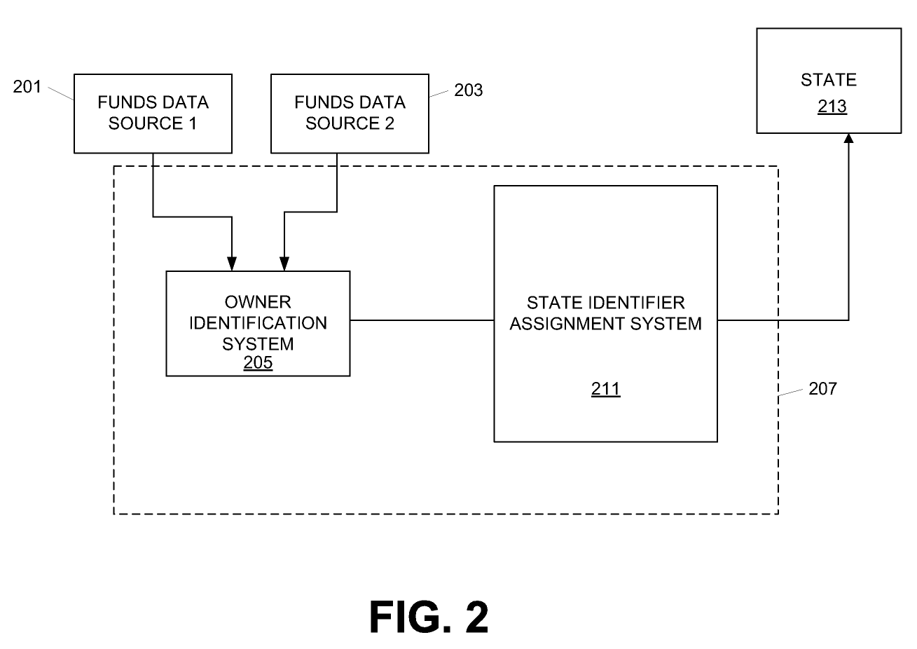

FIG. 2 illustrates one example network computing environment in which the escheatment process described herein may be implemented. The system may include unclaimed funds data received from various sources, such as sources 201 and 203. These sources may include external data sources such as the Federal Reserve, national clearinghouses such as SVPCO, any bank or other institution that handles the clearing of funds for checks, etc. and the like. In some examples, a customers may report extra monies themselves. The data may include various transactions or transaction amounts related to funds that have not been claimed by its owner. As used herein, unclaimed funds may include checks issued to an individual that were never cashed, refunds that were never received by the individual, checks that are presented by the funds are not credited to the payee, etc. As mentioned above, the unclaimed funds may be stored, for instance, at a financial institution, etc., for a predetermined period of time. Once the time period has passed, the funds may, by law, escheat to the last known state in which the rightful owner is a resident.

In order to escheat the funds to the proper state, the rightful owner of the unclaimed funds may be identified. Accordingly, the unclaimed funds data may be received at an owner identification system 205. The owner identification system 205 may receive data associated with the unclaimed transaction or transaction funds, such as a dollar amount, account number associated with the transaction or transaction funds, etc. The owner identification system 205 may then attempt to match the unclaimed transaction or transaction funds to customer information in order to identify the owner of the unclaimed funds. For instance, any information associated with the unclaimed funds may be matched with a customer name, account number, last known address of a customer, last known state of residence, etc. If a match is made, the unclaimed transaction or transaction funds are associated with the identified customer or customer information and transmitted to the state identifier assignment system 211. The state identifier assignment system 211 may then assign a state identifier to the unclaimed transaction or transaction funds. In some examples, assignment of the state identifier may include identifying a state code associated with the state of last known residence of the owner of the funds and associating that state code with the funds. This state identifier may then be used to determine which state the funds should escheat to. For instance, if a state identifier is assigned, the funds may then escheat to that state, such as state 213, at the appropriate time. In some arrangements, the owner identification system 205 and state identifier system 211 may be contained within the financial institution, such as financial institution 207. The state identifier may, in some examples, be a two digit code associated with the unclaimed funds. In other examples, the state identifier may be a multi-digit alpha-numeric code.

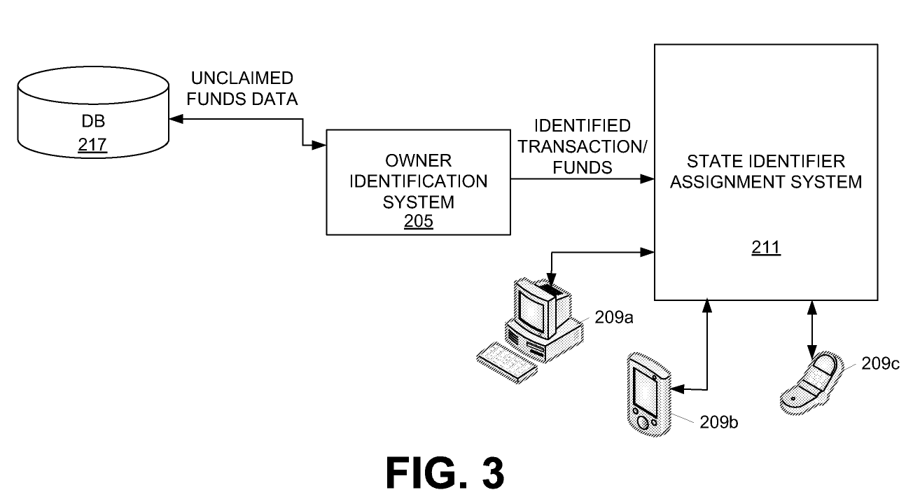

FIG. 3 illustrates an example data flow for processing unclaimed funds data and identifying a state to which the funds should escheat. For instance, unclaimed transactions or transaction fund data may be stored in a database, such as database 217. The data may be transmitted to the owner identification system 205, similar to the arrangement described above. The owner identification system may then process the unclaimed funds data and match known user information to the unclaimed transaction or transactions funds transmitted in the data. If a match is identified, the owner identification information is associated with the unclaimed transaction or transaction data and is transmitted to the state identifier identification system 211. In some examples, the state identifier assignment system 211 may be in communication with and configured to receive instructions from user terminals 209. For instance, a user may instruct the state identifier assignment system 211 to hold one or more escheatment transactions in order to transmit a batch of transactions at one time. In other examples, various reports may be generated regarding the unclaimed funds data, state identified, owner information, and the like. These reports may be transmitted to and/or manipulated by users via the user terminals 209.

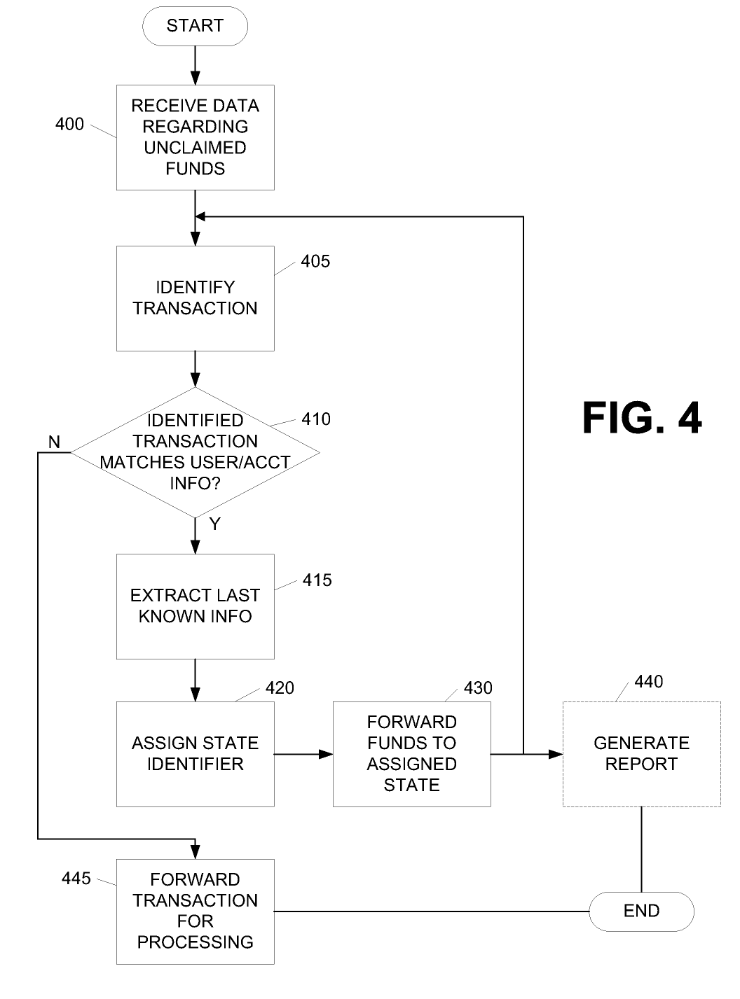

FIG. 4 illustrates one example method by which a financial institution may receive unclaimed funds data and automatically identify a user or owner associated with the funds and a state to which the funds should escheat. In step 400 data regarding unclaimed funds is received at the financial institution. For instance, data regarding one or more transactions or unclaimed transaction funds may be received at an owner identification system, such as system 205 (in FIGS. 2 and 3). In some examples, an unclaimed transaction or unclaimed funds associated with a transaction are identified in step 405. For instance, in some arrangements, one amount of unclaimed funds or unclaimed funds associated with a single transaction are identified, for instance, in order to identify an owner and/or a state to which the funds should escheat. Identification of one amount of funds or unclaimed funds associated with one transaction permits the owner identification system to attempt to match the unclaimed transaction or unclaimed transaction funds to an owner, as shown in step 410. Attempting to match the unclaimed transaction or unclaimed transaction funds to an owner may include matching data associated with the unclaimed transaction or unclaimed transaction funds, such as account number, amount of funds, name of owner, etc. with known information regarding various accounts, users, etc. If no match is obtained, the unclaimed transaction or unclaimed transaction funds may be forwarded for further processing in step 445.

If matching information is found and an owner of the unclaimed transaction or unclaimed transaction funds is identified in step 410, the owner information may be associated with the unclaimed transaction or unclaimed transaction funds and the last known state of residence information may be extracted from the identified owner information in step 415. In one or more arrangements, the state of residence information may be determined by interfacing with one or more external databases storing personal information for individuals (e.g., WHITEPAGES.COM). In step 420, a state identifier may be assigned to the unclaimed transaction or unclaimed transaction funds. The funds may then escheat to the state associated with the assigned identifier in step 430. In some examples, the funds may escheat to the state by electronic funds transfer (EFT), printing and mailing a physical check, etc. In other examples, the funds may escheat to a centralized area prior to being transferred to the appropriate state. The process may then review the received data to identify another transaction in step 405. Additionally or alternatively, one or more reports may be generated in optional step 440. The one or more reports may include listings of the unclaimed transactions or unclaimed transaction funds and associated identified owners, listing of the amounts of funds escheated to each state, and the like.

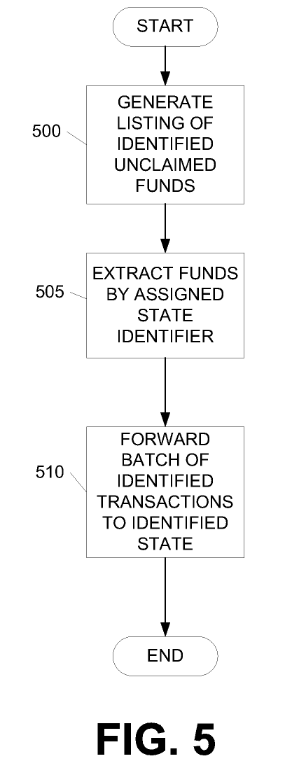

FIG. 5 illustrates one example alternate method of transmitting unclaimed transactions or unclaimed transaction funds to an identified state. In step 500 a listing of unclaimed transactions or unclaimed transaction funds with owners identified and states identifiers assigned may be generated. In step 505 states may be sorted by state identifier assigned and the funds associated with each state or a requested state may be extracted from the listing. In step 510 the batch of extracted transactions or funds may escheat to the state identified. In one or more examples, escheatments to a particular state may be held until a threshold number of escheatments are being held for that state. Once the threshold number has been reached, the funds may be escheated to the state in one batch as discussed herein.

The methods and features recited herein may further be implemented through any number of computer readable media that are able to store computer readable instructions. Examples of computer readable media that may be used include RAM, ROM, EEPROM, flash memory or other memory technology, CD-ROM, DVD, or other optical disc storage, magnetic cassettes, magnetic tape, magnetic storage and the like.

While illustrative systems and methods described herein embodying various aspects are shown, it will be understood by those skilled in the art that the invention is not limited to these embodiments. Modifications may be made by those skilled in the art, particularly in light of the foregoing teachings. For example, each of the elements of the aforementioned embodiments may be utilized alone or in combination or sub-combination with the elements in the other embodiments. It will also be appreciated and understood that modifications may be made without departing from the true spirit and scope of the present invention. The description is thus to be regarded as illustrative instead of restrictive on the present invention.

What is claimed is:

1. A method comprising:
identifying unclaimed funds to escheat to a state;
identifying last known information for an entity to which the unclaimed funds is owed;
associating a state identifier with the unclaimed funds, the state identifier identifying a last known state of residence associated with the unclaimed funds based on the identified last known information associated with the unclaimed funds; and
escheating the identified unclaimed funds to the identified state.

2. The method of claim 1, further including generating a report listing identified unclaimed funds and the associated identified state.

3. The method of claim 2, further including sorting the report listing identified unclaimed funds based on the associated identified state.

4. The method of claim 1, wherein the state identifier is a two digit code.

5. The method of claim 1, wherein identifying last known information associated with the unclaimed funds includes matching data associated with the unclaimed funds with data associated with an owner of the unclaimed funds.

6. A method, comprising:
receiving data associated with unclaimed funds;
identifying a transaction associated with at least a portion of the received unclaimed funds data;
matching the identified transaction to an owner;
responsive to identifying an owner matching the identified transaction, associating a state identifier with the identified transaction; and
escheating the unclaimed funds identified in the transaction to a state represented by the associated state identifier.

7. The method of claim 6, further including responsive to identifying an owner matching the identified transaction, extracting owner information from saved data associated with the owner.

8. The method of claim 7, wherein the owner information includes a last known state of residence.

9. The method of claim 7, wherein the step of extracting owner information includes interfacing with an external database.

10. The method of claim 9, wherein interfacing with the external database includes identifying location information for the owner.

11. The method of claim 6, further including responsive to determining that no owner matches the identified transaction, forwarding the identified transaction for additional processing.

12. The method of claim 6, wherein the state identifier is a two-digit code.

13. An apparatus comprising:
a processor; and
memory operatively coupled to the processor and storing computer readable instructions that, when executed, cause the apparatus to:
receive data associated with unclaimed funds;
identify a transaction associated with at least a portion of the received unclaimed funds data;
match the identified transaction to an owner;
responsive to identifying an owner matching the identified transaction, associate a state identifier with the identified transaction; and
escheat the unclaimed funds identified in the transaction to a state represented by the associated state identifier.

14. The apparatus of claim 13, further including responsive to identifying an owner matching the identified transaction, extract owner information from saved data associated with the owner.

15. The apparatus of claim 14, wherein the owner information includes a last known state of residence.

16. The apparatus of claim 14, wherein extracting owner information includes interfacing with an external database.

17. The apparatus of claim 16, wherein interfacing with the external database includes identifying location information for the owner.

18. The method of claim 13, further including responsive to determining that no owner matches the identified transaction, forward the identified transaction for additional processing.

19. One or more computer-readable media storing computer readable instructions that, when executed, cause an apparatus to perform a method, comprising:
receiving data associated with unclaimed funds;
identifying a transaction associated with at least a portion of the received unclaimed funds data;
matching the identified transaction to an owner;
responsive to identifying an owner matching the identified transaction, associating a state identifier with the identified transaction; and
escheating the unclaimed funds identified in the transaction to a state represented by the associated state identifier.

20. The one or more computer-readable media of claim 19, further including responsive to identifying an owner matching the identified transaction, extracting owner information from saved data associated with the owner.

21. The one or more computer-readable media of claim 20, wherein the owner information includes a last known state of residence.

22. The one or more computer-readable media of claim 20, wherein the step of extracting owner information includes interfacing with an external database.

23. The one or more computer-readable media of claim 22, wherein interfacing with the external database includes identifying location information for the owner.

24. The one or more computer-readable media of claim 19, further including responsive to determining that no owner matches the identified transaction, forwarding the identified transaction for additional processing.
